(19) United States
(12) Patent Application Publication
(10) Pub. No.: US 2006/0289423 A1
(43) Pub. Date: Dec. 28, 2006

(54) Mirror heater assembly

(76) Inventors: Jose Martinez, Franklin Park, IL (US); Michael N. Neenan, Crystal Lake, IL (US); Cary P. Moreth, Bloomingdale, IL (US); Joseph L. Rodawold JR., Wilmington, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/369,802

(22) Filed: Mar. 7, 2006

Related U.S. Application Data
(60) Provisional application No. 60/680,918, filed on May 13, 2005.
(60) Provisional application No. 60/706,826, filed on Aug. 9, 2005.

(51) Int. Cl. H05B 1/00

(52) U.S. Cl. 219/219

(57) ABSTRACT

A mirror heater assembly that eliminates the adhesive layer used for attaching the heater to the back plate includes, in one embodiment, a back plate having one or more slots formed or cut into the back plate. The slots further define one or more protrusions. The heater may include one or more slits cut into the heater. The slits may receive the protrusions and the protrusions will hold the heater onto the back plate. Other non-adhesive techniques of the mirror heater assembly of the invention that may be used to attach the heater to the back plate may include, by way of illustration, heat staking, fasteners, pins, posts, insert molding, and ultrasonic welding. The other side of the heater may be adhesively applied to the mirror through the use of a double-sided adhesive layer that on one side is applied over the heater and on the other side is applied to the mirror.

### CROSS REFERENCE TO RELATED APPLICATIONS

This Non-Provisional Application claims benefit to U.S. Provisional Application Ser. No. 60/680,918 filed May 13, 2005 and U.S. Provisional Application Ser. No. 60/706,826 filed Aug. 9, 2005.

### FIELD OF THE INVENTION

The present invention relates generally to mirror heater assemblies, and more particularly to outside mirror heater assemblies for automobiles.

### BACKGROUND OF THE INVENTION

It is known that mirror heaters and mirror heater assemblies are used with automobile mirrors to thaw ice or snow or prevent the formation of ice or snow on the mirrors. Known heater assemblies include a mirror, a heater and a back plate. The known assemblies have proven useful and satisfactory for their intended purpose. However, there continues to be a desire to improve upon existing assemblies.

In the known systems, the heater, such as a screen printed heater, is provided with an adhesive layer on both sides of the heater. One side is secured to the glass mirror and the other side is secured to the back plate. A known drawback with this assembly is that the adhesive can be relatively costly. Another known drawback is the adhesive layer and the adhesive liner that are secured to the heater must undergo a punching or similar processing step to properly configure the adhesive layer and liner to the heater.

Another drawback involves the use of heaters that include terminals that project outwardly from the heater. The adhesive layer and liner must be modified to accommodate these terminals. Moreover, costly peel tabs are provided on the liner to remove the liner from the adhesive layer. Alternatively, the liner is punched or adapted to provide a means to enable the assembler to remove the liner prior to assembly to the back plate. Since the adhesive layer and liner are placed on the heater, the punched hole will provide an edge or height difference to allow the removal of the liner. These processing steps add undesirable cost to the overall assembly. Another drawback with such assemblies is that an adhesive attachment means is sometimes not the most secure method of attaching the heater to the back plate.

The present invention addresses these and other areas of concern by providing a new and improved mirror heater assembly.

### SUMMARY OF THE INVENTION

In one aspect, the present invention includes a mirror heater assembly that eliminates the adhesive layer used for attaching the heater to the back plate. In an exemplary embodiment, the back plate may include one or more slots formed or cut into the back plate. The slots further define one or more protrusions. The heater may include one or more slits cut into the heater. The slits are configured to receive the protrusions and the protrusions will hold the heater onto the back plate. Other non-adhesive techniques of the invention that may be used to attach the heater to the back plate may include, by way of illustration, heat staking, fasteners, pins, posts, insert molding, and ultrasonic welding.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a partial plan view of an exemplary back plate for use with the present invention.

FIG. 2 is a plan view an exemplary heater for use with the present invention.

FIG. 3 is a cross-section view of the heater of FIG. 2 taken at line 3-3.

FIG. 4 is another cross-section view of the heater of FIG. 2 assembled to the back plate of FIG. 1.

FIG. 5 is a partial plan view of the assembled heater and back plate of FIG. 4.

FIG. 6 is a partial cross-section view of an alternative embodiment of the back plate.

FIG. 7 is a partial cross-section view of another alternative embodiment of the back plate.

FIG. 8 is an isometric view of an assembly of an alternative heater to an alternative back plate of the invention.

FIG. 9 is an isometric view of an alternative assembly of the heater and back plate of FIG. 8.

FIG. 10 is an isometric view of an alternative assembly of the heater and back plate of FIG. 8.

FIG. 11 is a bottom view of the assembly of FIG. 10.

FIG. 12 is a plan view of an alternative heater of the invention.

FIG. 13 is a plan view of exemplary adhesive layer and liner for use with the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

The present invention may be embodied in many forms. Referring to the Figures, there is depicted various aspects of various techniques to attach a mirror heater to a back plate without the use of adhesive. The mirror heater and back plate assembly may then be attached to a mirror for use with a vehicle.

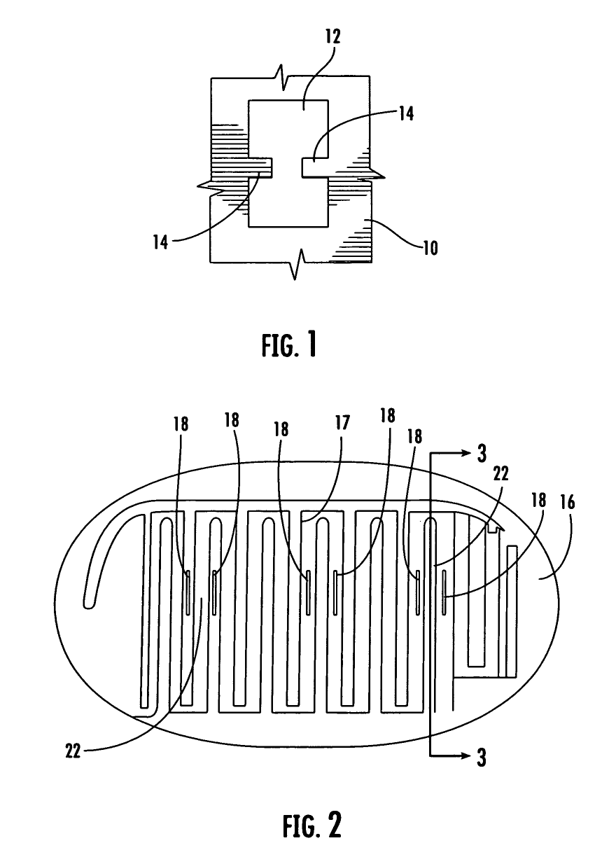

Referring to FIG. 1, in one embodiment, an exemplary back plate 10 for a mirror assembly is partially depicted. The exemplary back plate 10 may include one or more non-adhesive mounting members, such as one or more slots 12 formed or cut into the back plate 10. The slots 12 may define one or more protrusions 14. The number and spacing of slots 12 on the back plate 10 may vary depending on the application. As shown in FIG. 1, the protrusions 14 extend inwardly toward the central opening of the slot 12 and toward each other to define a support structure to hold a heater 16 in position on the back plate 10, as discussed below. The slots 12 may define an H-shaped configuration as depicted in FIG. 1, or any other configuration. Similarly, the protrusions 14 may define numerous possible shapes and configurations to serve as a support structure to hold the heater 16 to the back plate 10.

Referring to FIG. 2, an exemplary heater 16 is depicted. The heater 16 may be any type of known mirror heater commonly found in outdoor mirror heater assemblies for vehicles. For example, the heater 16 may be positive temperature coefficient heaters (PTC), fixed resistance heaters, or the like, and may be made from Mylar or any other suitable material. As shown in FIG. 2, the heater 16 may also include any known electric circuit 17 formed in or attached to the heater 16. The electric circuit 17 may define numerous possible configurations.

As depicted in FIG. 2, the heater 16 may be provided with at least one slit 18 adapted to engage with the protrusion 14 of the back plate 10. In the illustrated embodiment, for each protrusion 14 in the back plate 10, there is provided a slit 18 in the heater 16. In this way, each protrusion 14 may engage each slit 18 to attach the heater 16 to the back plate 10. In an exemplary embodiment, multiple slits 18 configured in a substantially parallel and space-apart manner may be incorporated into the heater 16, though other configurations are possible. The slits 18 may form a heater portion 22 between the slits.

Referring to FIG. 3, a cross-section of a portion of the heater 16 taken at line 3-3 (FIG. 2) is depicted to illustrate a loop 20 formed by the slits 18. By providing slits 18 configured in the substantially parallel and spaced-apart manner (FIG. 2), the heater portion 22 between the slits 18 may be pushed or pulled to create the loop 20 depicted in FIG. 3. The loop 20 defines the opening through which the protrusion 14 may pass to attach the heater 16 to the back plate 10.

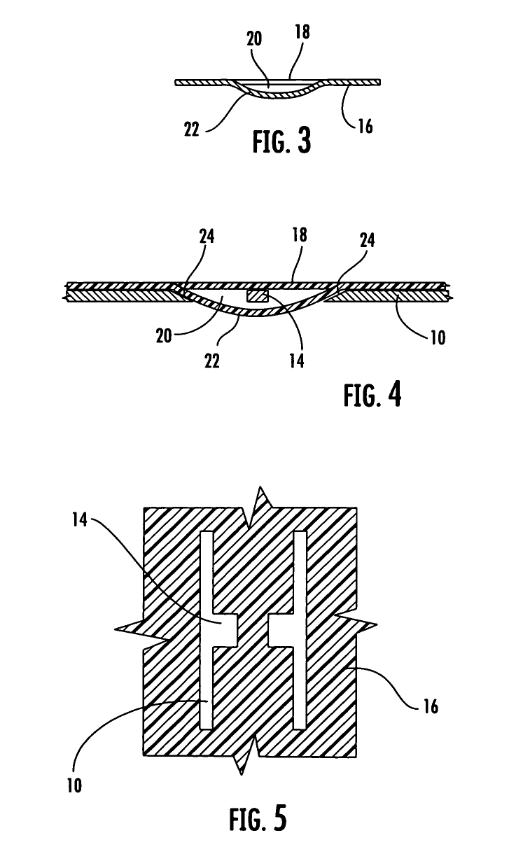

To assemble the heater 16 to the back plate 10, the heater 16 is laid across the back plate 10 and the heater portion 22 that forms the loop 20 is pushed through the slot 12 and past the opposing protrusions 14. A tool or other suitable device may be used to push the heater portion 22 into the slot 12 and past the protrusions 14. Referring to FIG. 4, which depicts a cross-section of the heater and back plate assembly, the loop 20 (formed by the heater portion 22 and slits 18) may pass across (either over or under) the protrusion 14. Referring to FIG. 5, the opposing protrusions 14 will hold the heater 16 onto the back plate 10 at the location of the protrusions and prevent the heater 16 from being lifted or pulled off the back plate 10.

Returning back to FIG. 4, in one embodiment of the back plate 10, the back plate may define edges having angled opposing surfaces 24 that form a lead-in for the loop 20 to extend below the protrusion 14. The angled surfaces 24 facilitate the insertion of the loop 20 below the protrusion 14 and prevent sharp edges of the back plate 10 from cutting or tearing the heater 16 as it is inserted below the protrusion. Additionally, the angled surfaces 24 permit the gradual transition of the loop 20 around the protrusion 14.

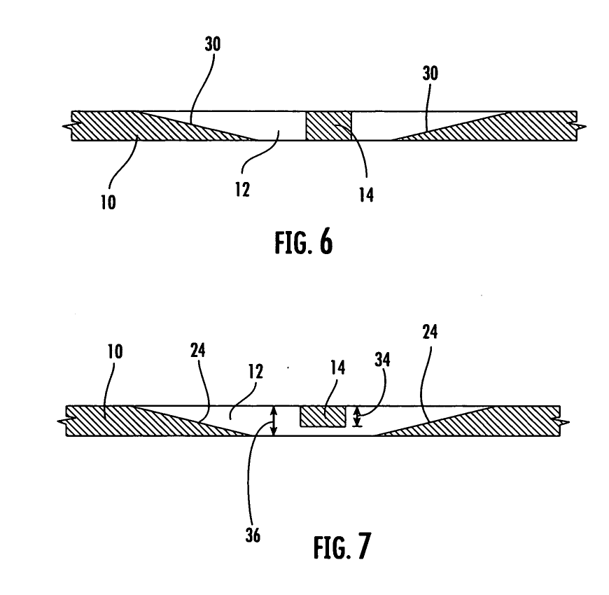

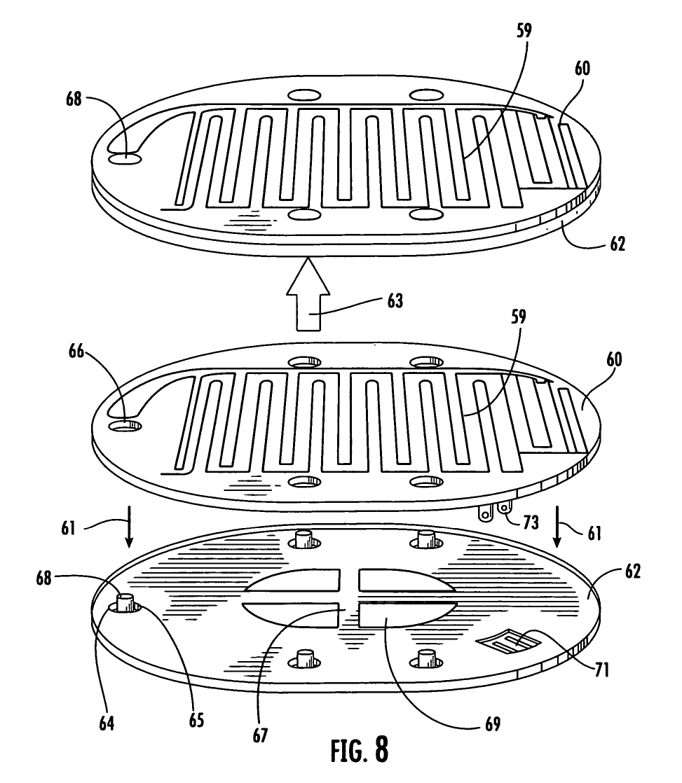

Referring to FIG. 6, a cross-section of another exemplary embodiment of the back plate 10 is depicted. This embodiment may be used to minimize post-assembly deflection of the heater after the heater has been installed on the back plate. With this embodiment, the lead-in angled surfaces of the slots 12 may be increased. That is, angled surfaces 30 may provide a more gradual lead-in for the heater portion 22 (FIG. 4).

Referring to FIG. 7, a cross-section of still another exemplary embodiment of the back plate 10 is depicted that may be used as a technique for minimizing post-assembly deflection of the heater. In this embodiment, the thickness of the protrusion 14 may be reduced. In one aspect, the thickness 34 of the protrusion 14 may be less than the thickness 36 of the back plate 10. With this configuration, there will be a more gradual transition of the heater portion 22 around the protrusion 14, resulting in less deflection of the heater portion 22 and the heater 16.

In another alternative technique for minimizing post-assembly deflection of the heater, the slits 18 (FIG. 2) formed in the heater 16 may be increased in length or, alternatively, an additional relief may be cut into the heater 16 at the ends of the slits 18. These embodiments may further minimize any post-assembly deflection of the heater 16.

Referring to FIGS. 8-13 there is illustrated various aspects of other embodiments of the invention. The alternative embodiments include alternative techniques to attach a mirror heater to a back plate without the use of adhesive. By way of illustration, these techniques include, but are not limited to, heat staking, insert molding, and ultrasonic and spin welding, and may include the use of non-adhesive mounting members such as fasteners, rivets, pins, posts, and the like.

In an exemplary embodiment shown in FIG. 8, a heat staking technique may be used to attach a heater 60, such as a PTC or fixed resistance heater, to a back plate 62. The heater 60 may be constructed on a substrate of dielectric material, such as Mylar, with a circuit element 59 formed with or attached to the substrate. The circuit element 59 may define any suitable configuration, including the exemplary configuration depicted in FIG. 8. The heater 60 may have spaced apart holes 66 positioned in various locations on the heater 60 for use in the heat staking procedure.

A back plate 62 may have, depending on the embodiment, predefined, spaced-apart attachment points to join the back plate 62 to the heater 60. The attachment points may be in the form of holes or slots to coincide with posts or pins either molded into the back plate or added as a separate component. In one embodiment, the back plate 62 may include a plurality of holes 64 having posts 68 extending outwardly from the holes 64. The posts 68 are configured to align with the holes 66 in the heater 60 during assembly. The posts 68 may be made of any material suitable for use in a heat staking procedure.

The assembly of the heater 60 to the back plate 62 is illustrated by direction arrows 61. During the assembly operation, the heater 60 may be placed on the back plate 62 as indicated by direction arrows 61 using the posts 68 as guides to align the heater 60 onto the back plate 62 vis-à-vis the holes 66. After the heater 60 has been placed on the back plate 62 using the posts 68 and holes 66, the heat stake operation may be performed on the posts 68, thereby attaching the heater 60 to the back plate 62.

The holes 64 in the back plate 62 may be surrounded by a respective recess 65. The recess 65 may be used to receive the post 68 material after the post 68 has been heat staked. In this manner, the post material may be melted so that the material lies substantially flat with the surface of the heater 60 and any excess post material may be received by the recess 65. In an exemplary embodiment, the recess 65 may have a depth of approximately 0.030 inches and a diameter of approximately 0.300 inches. As depicted, the hole 64 is positioned in the center of the recessed area 65 with the post 68 extending outwardly from the hole 64.

The back plate 62 may define a web shaped configuration or spoked wheel configuration 67 forming one or more openings 69 to permit the back plate to be made of less material and to minimize the effect of the back plate acting as a heat sink, as discussed below. The back plate 62 may further include a socket 71 for receiving a terminal 73 of the heater 60. The socket 71 may define any suitable configuration to receive the terminal 73.

Upon heat staking, the arrow 63 identifies the combined heater 60 and back plate 62 assembly. As indicated above, the recesses 65 in the back plate 62 are adapted to receive the post 68 material during heat staking so the heater 60, once installed, may lie substantially flat against the back plate 62. The heater may then be properly placed against the mirror. In sum, upon heat staking, the heater 60 near the holes 66 is captured between back plate 62 and the melted material of the posts 68.

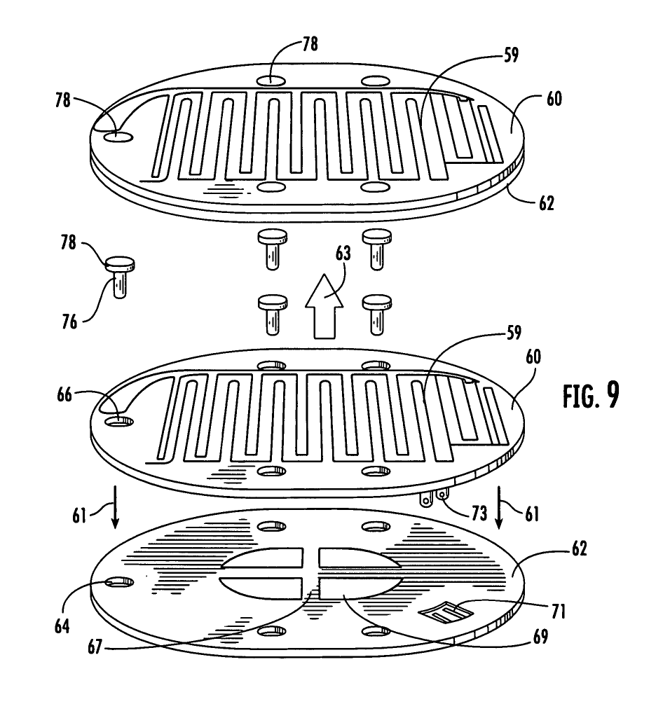

Another exemplary embodiment is depicted in FIG. 9. The embodiment illustrated in FIG. 9 is similar to the embodiment of FIG. 8 except the posts 68 are replaced with pins 76 molded, formed or assembled to the back plate 62. The pins 76 may also be fasteners, rivets or the like. The pins 76 may define heads 78. Upon heat staking, press-fitting, or fastening, the heater 60 is captured between the back plate and the heads 78 of the pins 76. If a heat staking procedure is used, the heads 78 will flatten out over a portion of the heater 60 and hold the heater onto the back plate. Alternatively, the heads 78 may be pushed through the holes 66 in the heater until all surfaces are flush and then the pins 76 may be heat staked to the back side of the heater 60.

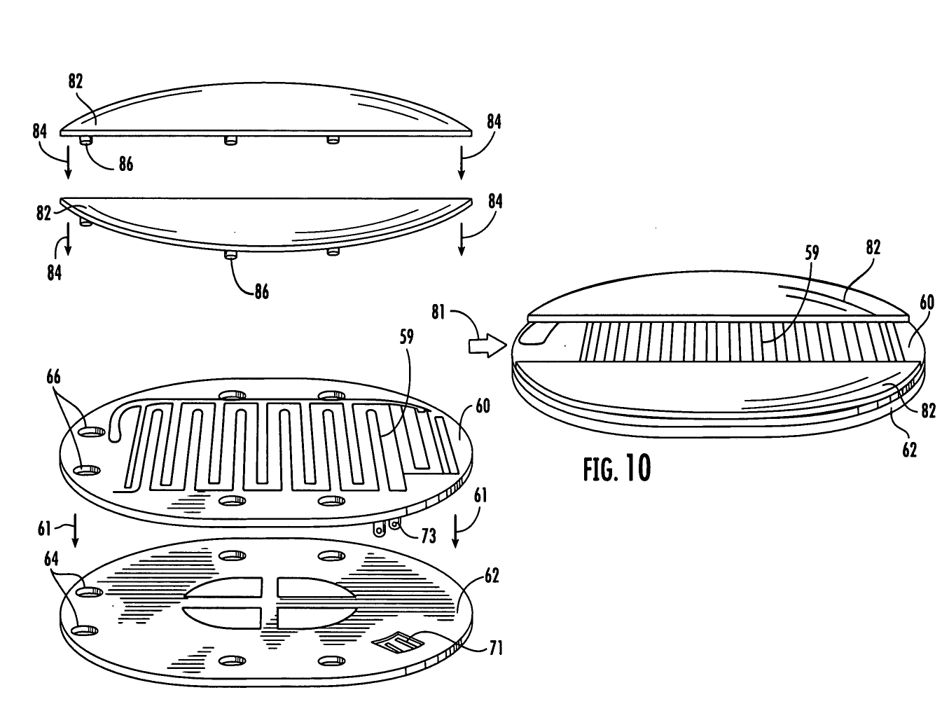

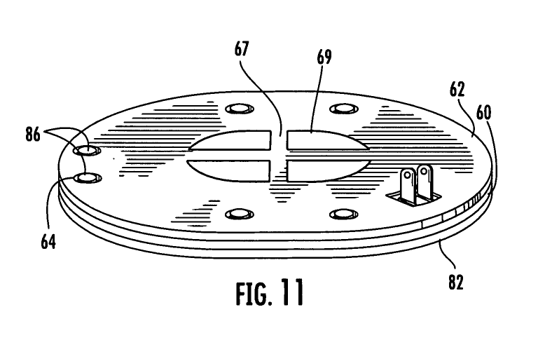

Another exemplary embodiment is illustrated in FIG. 10. This embodiment is similar to the embodiment of FIG. 8 in that the heater 60 may be constructed in the same manner as described above and may include predefined holes 66 for attachment to the back plate 62. The back plate 62 may also have predefined holes 64 that, during assembly, may align with the holes 66 in the heater 60. With this embodiment, flat strips 82 of material that may be the same material as the back plate material may have posts 86 extending outwardly from the strips 82. The posts 86 may align with the holes 64, 66 in the back plate and heater, respectively. Each strip 82 may be assembled as indicated by direction arrows 84 and each strip 82 will hold the heater 60 and back plate 62 together, with the posts 86 extending through the holes 66 in the heater 60 and engaging the holes 64 in the back plate 62. The posts 86 may be heat staked to hold the assembly together. Direction arrow 81 identifies the assembled embodiment.

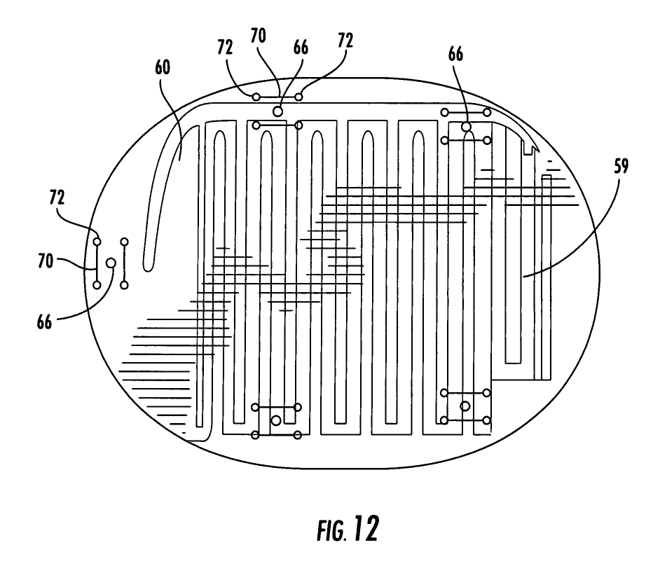

FIG. 11 shows a bottom view of the embodiment of FIG. 10. The posts 86 may extend to the bottom of the back plate 62 and may be heat staked or press fit to the back plate 62, in the manner described above. The back plate 62 may define a web shaped configuration 67 forming one or more openings 69 to permit the back plate to be made of less material. This configuration will also minimize the effect of the back plate acting as a heat sink, as explained below.

In yet another embodiment, the heater 60 may be bonded to the back plate 62 through the use of ultrasonic welding or spin welding. With the ultrasonic welding technique, the heater may be joined to the back plate through the local application of pressure and high-frequency vibratory energy. All or a portion of the heater may be ultrasonically welded to the back plate, depending on the application and the desired level of attachment of the heater to the back plate. With the spin welding technique, the heater may be welded to the back plate at various locations through the use of any suitable known machine that will cause one part to spin against a second part until the heat of friction between the parts reaches a sufficient level for the parts to weld together.

Still another technique to attach the heater 60 to the back plate 62 is through the use of insert molding. Using this technique, the heater may be placed in a mold and the back plate 62 may be formed around the heater, thereby joining the heater and back plate together in the same operation. Still other techniques may be used to attach the heater to the back plate.

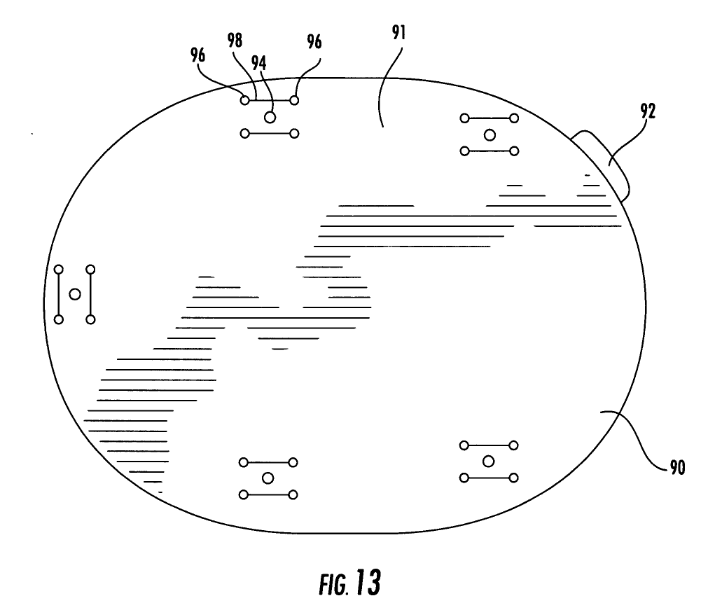

In an alternative embodiment of the heater 60, illustrated by FIG. 12, the heater 60 may be provided with a series of relief slits 70 and relief holes 72 around the main staking holes 66 to provide stress relief in the heater 60 upon heat staking. The holes 72 at the ends of the slits 72 are used to further prevent the heater material from ripping when subjected to outside forces, such as during assembly or even operation. In other words, the slits 70 in the heater 60 adjacent to the main staking holes 66 may be used to help relieve the pressure in the heater 60 when heat staked, to thereby maintain flatness of the heater 60 after installation. The holes 72 in the ends of the slits 70 are used to relieve the stress in the slits 70 so that the heater does not rip during or after assembly.

As described below, an adhesive layer having a release liner may be applied over the heater 60. The adhesive layer may be used to adhere the heater 60 to the glass mirror. This adhesive layer may have pre-cut holes and slits that align with the holes 66 and 72 and slits 70 so that the release liner may be removed without leaving any liner residue.

FIG. 13 shows a top view of an exemplary adhesive layer 90 that may be overlaid onto the heater 60. For some applications, the adhesive layer 90 may not be required, as discussed below. If used, however, the adhesive layer 90 may be a double-sided adhesive layer that on one side may be adhered to the heater 60 and, on the other side, may include a release liner 91. The release liner 91 may be removed by the customer or user by pulling on a pull tab 92 to expose the underlying adhesive side. The exposed adhesive side may then be applied to the mirror, not shown, to adhere the heater and back plate to the mirror. While the liner 91 is shown with a pull tab 92, other configurations are suitable. The adhesive layer 90 and liner 91 may include pre-cut holes 94, 96 to align with the holes 66, 72 of the heater 60, and also pre-cut slits 98 that align with the slits 70 of the heater 60, as depicted in FIG. 12. The pre-cut holes and slits will permit the liner 91 to be removed without leaving any liner residue.

Alternatively, the adhesive layer 90 may be insert molded to the heater at the peripheral edge of the heater. In this embodiment, the adhesive layer 90 may be placed in a mold machine and plastic or other suitable material is molded around the peripheral edge of the heater 60 to provide a lip or similar sturdy structure around the adhesive layer 90. The liner 91 may be removed and the underlying adhesive side may then be adhered to the mirror.

In known mirror heater assemblies, the back plate is provided with enough surface area of material to enable the known adhesive on the heater to be secured to the back plate. It is also known that during operation of the heater, the back plate acts as a heat sink detracting from the overall operation and efficiency of the heater. With the principles of the invention, and by eliminating the adhesive layer used between the heater and the back plate, the back plate according to the invention may include substantially less material to minimize the heat sink effect. For example, in one embodiment shown in FIG. 8, the back plate 62 may be configured as a spoked wheel 67, or any suitable web-like configuration that defines a plurality of openings 69. Alternatively, in another embodiment, a lip (not shown) may be molded around the peripheral edge of the back plate 62 with a cross-shaped middle section having numerous openings. Other configurations of the back plate 62 are possible. With these configurations, the back plate will be rigid enough to cooperate with the known actuator that is coupled to the back plate to enable movement of the mirror, as understood in the art. Consequently, the described embodiments permit the proper cooperation with the known actuator as well as the proper movement of the mirror within the mirror housing while significantly reducing the amount of material for the back plate to thereby improve the heater performance.

With the embodiments described herein, the adhesive previously used in the construction of known mirror/heater assemblies has been eliminated. The operation of the heater will be improved since there will be less material used in the back plate, which could act as a heat sink to degrade the performance of the heater. There will be less material in the back plate as it may be designed to be mainly open because no adhesive will be needed to bond the heater to the back plate and thus no plastic in the back plate is required to bond the two components. Additionally, with the open back plate design, there will be improved heater performance because the back plate will not act as a heat sink. Also, the elimination of the adhesive layer results in an assembly that is less costly and less prone to failure. Further, there will be a possible reduction of assembly operations at the customer level. One of skill in the art will appreciate that the embodiments of the inventions may be used in any type of assembly where the heater may be part of a mirror or other component assembly.

In another embodiment, and depending on the application, it may be desirable to eliminate the use of the adhesive layer typically used to adhere the heater to the mirror. Currently, and as described above, a double-sided adhesive layer may be used to adhere the heater to the mirror. As explained above, this adhesive layer will cover and protect the heater circuit, and once the release liner is pulled away, the heater may be attached to a mirror. In certain applications, however, it may be desirable to eliminate the step of removing the liner on the mirror side of the heater. Consequently, according to one embodiment, a dielectric layer (non-conductive layer such as Mylar) may be applied to the mirror side of the heater circuit to protect the circuit. This would also prevent the circuit from being positioned directly against the mirror. The opposite side of the heater already has a Mylar layer and is adapted for placement next to a back plate, using adhesive or any of the techniques described herein. The assembly could then be shipped to the customer and the customer could use hot melt or any other adhesive or other attachment techniques to secure the assembly to a mirror. The customer could use a manual adhesive applicator or an automatic application machine. With this embodiment, the double-sided adhesive layer and the adhesive liner would no longer be required.

In another embodiment, the heater may be assembled to the back plate using any of the techniques described herein, or through the conventional use of adhesive. In addition, and rather than using an adhesive layer to attach the heater to the mirror, the mirror side of the heater may be coated with any suitable coating material. The heater may then be subsequently attached to the mirror using any known attaching technique. With this embodiment, one of the known adhesive layers is still eliminated.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A mirror heater assembly for use with a vehicle comprising:
a back plate defining at least one slot that further defines at least one protrusion, and
a heater having at least one slit formed in the heater, the slit configured to receive the at least one protrusion of the back plate.

2. The mirror heater assembly of claim 1 wherein the back plate defines multiple slots each having at least one protrusion.

3. The mirror heater assembly of claim 2 wherein the heater has two slits configured to receive the at least one protrusion.

4. The mirror heater assembly of claim 3 wherein the slits are spaced apart and substantially parallel.

5. The mirror heater assembly of claim 1 wherein the at least one slot is H-shaped to define opposing protrusions.

6. The mirror heater assembly of claim 1 further comprising an adhesive layer applied over the heater to permit the mounting of the heater to a mirror.

7. The mirror heater assembly of claim 5 wherein the H-shaped slot defines edges that are angled.

8. The mirror heater assembly of claim 7 wherein the back plate defines a thickness and wherein the opposing protrusions define a thickness that is less than the thickness of the back plate.

9. A mirror heater assembly for use with a vehicle comprising:
a back plate defining a plurality of spaced-apart back plate holes,
a heater defining a plurality of spaced apart heater holes, and
non-adhesive mounting members attaching the heater to the back plate.

10. The mirror heater assembly of claim 9 wherein the non-adhesive mounting members are selected from the group consisting of pins, posts, rivets and fasteners.

11. The mirror heater assembly of claim 9 wherein the non-adhesive mounting members are heat staked to the back plate.

12. The mirror heater assembly of claim 9 wherein the back plate defines a web-shaped body.

13. The mirror heater assembly of claim 9 further comprising an adhesive layer applied over the heater to permit the mounting of the heater to a mirror.

14. The mirror heater assembly of claim 9 wherein the non-adhesive mounting members are strips that include outwardly extending posts that engage the plurality of holes in the heater and the back plate.

15. The mirror heater assembly of claim 9 wherein the heater defines a plurality of relief slits and relief holes configured adjacent to the plurality of heater holes.

16. The mirror heater assembly of claim 9 wherein the heater is a positive temperature coefficient heater.

17. A mirror heater assembly for use with a vehicle comprising:
a back plate, and
a heater defining a first adhesive side and a second non-adhesive side, the heater mountable to the back plate.

18. The mirror heater assembly of claim 17 wherein the heater is mountable to the back plate through the use of non-adhesive mounting members.

19. The mirror heater assembly of claim 18 wherein non-adhesive mounting members are selected from the group consisting of pins, posts, rivets and fasteners.

20. The mirror heater assembly of claim 19 wherein the heater defines a plurality of holes and a plurality of slits.
